(19) United States
(12) Patent Application Publication
(10) Pub. No.: US 2019/0116344 A1
(43) Pub. Date: Apr. 18, 2019

(54) MULTIPLE IMAGE PLANE HEAD-UP DISPLAY

(71) Applicant: VISTEON GLOBAL TECHNOLOGIES, INC., Van Buren Township, MI (US)

(72) Inventors: GIANG-NAM NGUYEN, KARLSRUHE (DE); PATRICK NEBOUT, SAINT-CLOUD (FR); BENOIT CHAUVEAU, MERY SUR OISE (FR)

(21) Appl. No.: 15/785,691

(22) Filed: Oct. 17, 2017

(51) Int. Cl. H04N 9/31; G02B 27/01; G02F 1/29; B60K 35/00

(52) U.S. Cl. CPC H04N 9/3147; B60K 2350/352; G02B 27/0149; G02F 1/292; H04N 9/3161; H04N 9/312; H04N 9/317; B60K 35/00; G02B 2027/0154; G02B 2027/011; G02B 2027/015; B60K 2350/2052; B60K 2350/2034; B60K 2350/2047; G02B 27/0101

(57) ABSTRACT

A multi-image head-up display device for displaying a plurality of virtual images at different projection distances from a driver of a vehicle includes a picture generating unit with an illumination source that may include a plurality of lasers of different colors to illuminate a spatial light modulator with a first light beam. The spatial light modulator includes blocks of modulating elements to diffract the first light beam to form first and second real images upon first and second respective projection surfaces, each spaced apart from the spatial light modulator by a different focal length. The blocks may be configured as Fourier and/or Fresnel diffractive optical elements. A projection assembly may magnify and direct the real images to the viewer as virtual images each having a different projection distance from the viewer. A method for generating a plurality of virtual images with a head-up display device is also provided.

### BACKGROUND

It is known from the state of the art how to project information in the field of sight of a user, such as, for example, a driver or a pilot, by means of a head-up display, or HUD.

Such head-up displays generally feature a picture generating unit, which provides the information to be represented in the form of an image, an optical module, which permits the beam path through the head-up display to the output opening and which is also referred to as mirror optics, as well as a projection surface, for the display of the image that is to be generated. The optical module guides the image onto the projection surface, which is designed as a reflective, transparent disc and is also referred to as a combiner. In a special case, a windshield that is appropriate for this use is employed as a projection surface. The vehicle driver contemporaneously sees the mirrored information of the picture generating unit and the actual surroundings behind the windshield. The attention of the vehicle driver, for example, when driving a motor vehicle, therefore remains focused on that which is occurring in front of the vehicle, while they are able to grasp the information that is projected in the field of vision.

Using a known head-up display (HUD), it is possible to generate a virtual image in a plane with a determined distance to the viewer. In the case of need for a representation of two or multiple virtual images, which are to be represented at varying distances or planes, it is generally necessary to employ two or more picture generating units. The problem with such a solution is a greatly increased need not only in the installation space required in the vehicle in the dashboard area, but also in the costs of two separate picture generating units. Therefore, there exists a need for a multi-image head-up display capable of displaying two or more virtual images at different distances from the viewer and which does not require two or more picture generating units.

### SUMMARY

A multi-image head-up display device for displaying a plurality of virtual images at different projection distances from a viewer is provided. The multi-image head-up display device includes a picture generating unit (PGU) having an illumination source to illuminate a spatial light modulator (SLM) with a first light beam. The spatial light modulator may include a first block of modulating elements to diffract the first light beam according to a first diffraction pattern to form a first real image upon a first projection surface spaced apart from the spatial light modulator by a first focal length. The spatial light modulator may also include a second block of modulating elements to diffract the first light beam according to a second diffraction pattern to form a second real image upon a second projection surface spaced apart from the spatial light modulator by a second focal length different from the first focal length.

A method for generating a plurality of virtual images with a multi-image head-up display device including a spatial light modulator (SLM) having a first block of modulating elements and a second block of modulating elements is also provided. The method includes the steps of: providing a first projection surface spaced apart from the spatial light modulator by a first focal length; providing a second projection surface spaced apart from the spatial light modulator by a second focal length; and illuminating the spatial light modulator with a first light beam by an illumination source. The method proceeds with the steps of: setting the first block of modulating elements of the spatial light modulator according to a first diffraction pattern to cause the first block to function as a diffractive optical element (DOE); diffracting the first light beam by the first block of modulating elements of the spatial light modulator to form a first real image upon the first projection surface; setting the second block of modulating elements of the spatial light modulator according to a second diffraction pattern to cause the second block to function as a diffractive optical element (DOE); and diffracting the first light beam by the second block of modulating elements of the spatial light modulator to form a second real image upon the second projection surface.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a side view showing the relative positions of two virtual images at different projection distances from the driver of a vehicle;

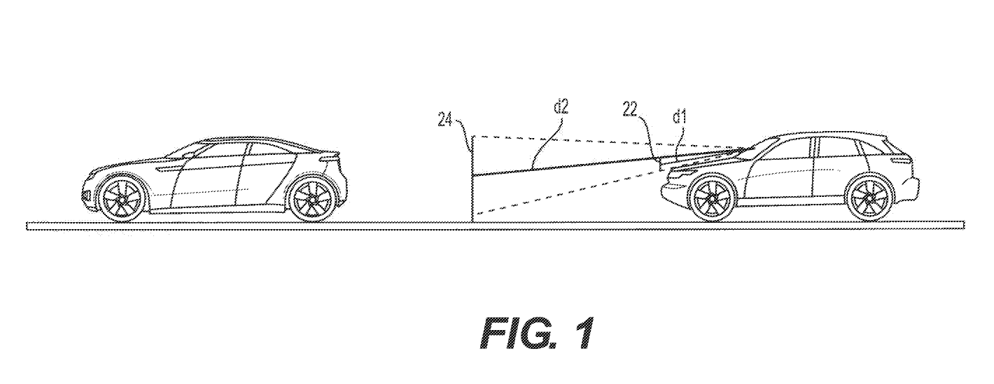

FIG. 2 is a viewer's perspective showing the relative positions of two virtual images at different projection distances;

FIG. 3 is a schematic of an embodiment of a multi-image head-up display device; and

FIG. 4 is a schematic of another embodiment of a multi-image head-up display device.

### DETAILED DESCRIPTION

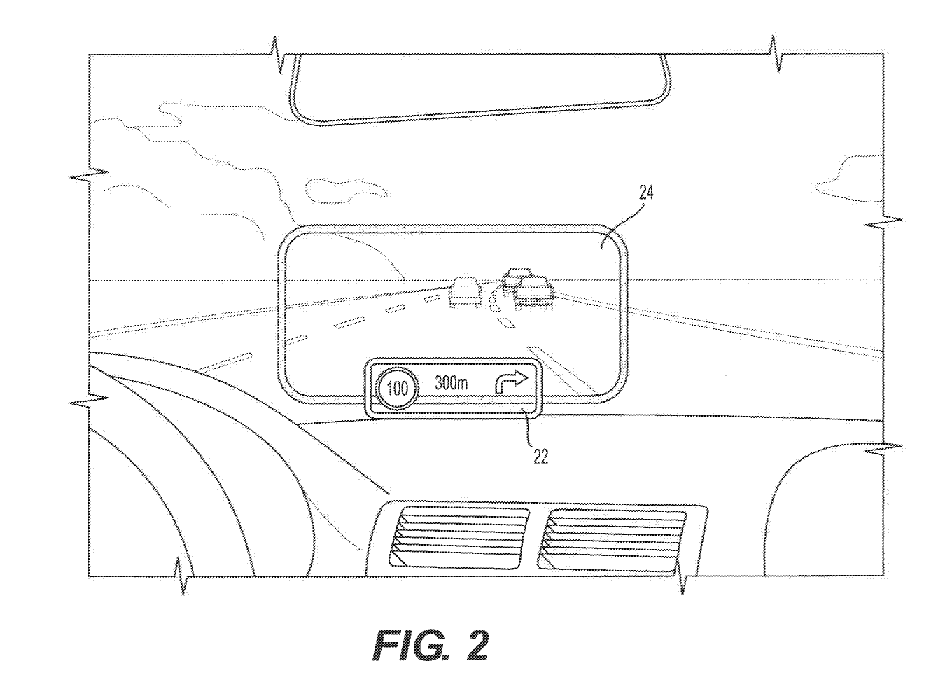

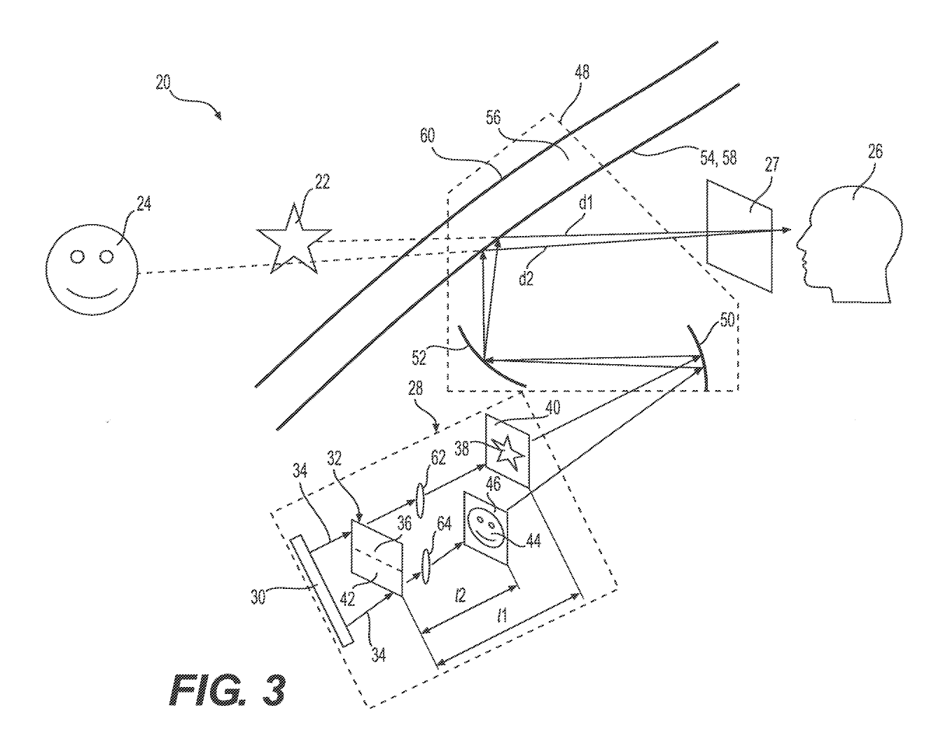

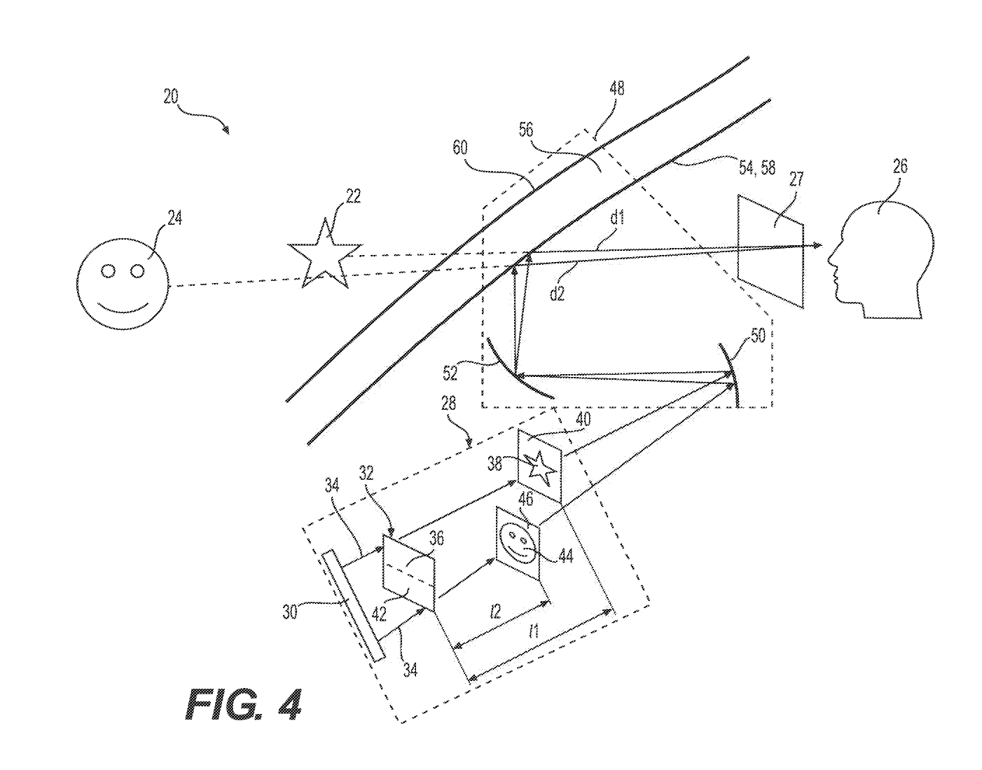

Referring to the Figures, wherein like numerals indicate corresponding parts throughout the several views, a multi-image head-up display device 20 for displaying a plurality of virtual images 22, 24 superimposed over a field of view and at different projection distances d1, d2 from a viewer 26, who may be the driver of a vehicle, is provided. As shown in FIG. 2, two virtual images 22, 24 may displaying critical information at a short distance and augmented reality information at a long distance away from the driver's eyes (e.g. speed and navigation at 2 m, and lane tracking, object detection, etc. at 15 m). As shown in FIGS. 3-4, the multi-image head-up display device 20 may display two or more virtual images 22, 24 at different projection distances d1, d2 from an eye box 27 region of space representing a range of normal viewing positions of a viewer 26. The multi-image head-up display device 20 including a picture generating unit 28 (PGU) with an illumination source 30 that may include a plurality of lasers of different colors to illuminate a spatial light modulator 32 (SLM) with a first light beam 34. It should be appreciated that the illumination source 30 may have a single color, such as from a single laser. Alternatively, the illumination source 30 may have multiple colors from sources of different colors or by other means such as, for example, by using colored filters.

According to an aspect, and as shown in FIGS. 3-4, the spatial light modulator 32 includes a first block 36 of modulating elements to diffract the first light beam 34 according to a first diffraction pattern to form a first real image 38 upon a first projection surface 40 spaced apart from the spatial light modulator 32 by a first focal length 11. The spatial light modulator 32 may also include a second block 42 of modulating elements to diffract the first light beam 34 according to a second diffraction pattern to form a second real image 44 upon a second projection surface 46 spaced apart from the spatial light modulator 32 by a second focal length 12 different from the first focal length 11.

One or more of the blocks 36, 42 of modulating elements may be independently dynamically adjustable, such as, for instance by corresponding control signals. For example, each of the blocks 36, 42 of modulating elements may be adjustable by a display signal from video processor to cause corresponding real images 38, 44 to be varied. In this way, the corresponding virtual images 22, 24 may be dynamically changed. The virtual images 22, 24 may have different information displayed in different modes, and/or may show items that change depending on operating conditions of the vehicle or other systems. For example, as shown in FIG. 2, the virtual images 22, 24 may include ADAS information, navigational instructions, the current speed limit, and/or indicators representing vehicles or other obstacles on the road, etc.

According to an aspect, the spatial light modulator 32 may include a reflective device that causes the first light beam 34 to be diffracted as the first light beam 34 is reflected by the modulating elements thereof. Such a reflective device may be, for example, a Liquid Crystal on Silicon (LCoS) device. Alternatively, the spatial light modulator 32 may include a transmissive device that causes the first light beam 34 to be diffracted as the first light beam 34 is transmitted through the modulating elements thereof. Such a transmissive device may be, for example, a Liquid Crystal Display (LCD) device which may be similar to the type used in overhead projectors. According to a further aspect, the spatial light modulator 32 may be monolithic to include both of the blocks 36, 42 of modulating elements together on one physical device. For example, the blocks 36, 42 of modulating elements may be separate regions of a single Liquid Crystal on Silicon (LCoS) SLM device. One or more of the blocks 36, 42 of modulating elements may produce a far-field diffraction pattern, particularly if the first light beam 34 is formed of a collimated light such as is produced by a laser.

According to an aspect shown in the embodiment of FIG. 3, a first converging lens 62 may be provided between said spatial light modulator 32 said first projection surface 40. A second converging lens 64 may also be disposed between said spatial light modulator 32 said second projection surface 46. Each of the converging lenses 62, 64 may function to bring the far-field diffraction pattern from the spatial light modulator 32 to the focal plane of the lens, which may be the respective one of the projection surfaces 40, 46. Such a configuration may be accomplished, for example where one or more of the blocks 36, 42 of the spatial light modulator 32 is configured as a diffractive optical element according an iterative Fourier transform algorithm (hence Fourier DOE).

According to an aspect shown in the embodiment of FIG. 4, light may be projected directly from the spatial light modulator 32 to the projection surfaces 40, 46 with no intermediate optical elements therebetween. Such a configuration may be accomplished, for example where one or more of the blocks 36, 42 of the spatial light modulator 32 is configured according to a Fresnel pattern to project one of the real images 38, 44 upon a corresponding one of the projection surfaces 40, 46. A block configured with a Fresnel pattern may be called a Fresnel Diffractive Optical Element (Fresnel DOE). A Fresnel DOE can also be calculated by adding the phase of a Fourier DOE with the phase function of a lens with a focal length equal to the distance between the block 36, 42 and the corresponding one of the projection surfaces 40, 46.

As shown in FIGS. 3-4, the head-up display device 20 may further include a projection assembly 48 which may magnify and direct the real images 38, 44 to the viewer 26 as the first virtual image 22 having a first projection distance d1 from the viewer 26 and as the second virtual image 24 having a second projection distance d2 from the viewer 26. The virtual images 22, 24 may each have projection distances d1, d2 that are different from one another. The projection assembly 48 may include a first mirror 50, which may be a concave mirror, and a second mirror 52, which may be a concave mirror, and a combiner 54 or windshield 56 to combine reflected views of the real images 38, 44 with the field of view.

According to an aspect, the first mirror 50 may be used to fold the optical path and reflect the real images 38, 44 from the projection surfaces 40, 46 to the second mirror 52. The folded optical path may allow for the projection assembly 48 to occupy a reduced package size, which may allow it to be placed, for example, within the dashboard of a vehicle. According to another aspect, the second mirror 52 may be tiltable for adjusting the location of the virtual images 22, 24 on the combiner 54. The adjusted location of the virtual images on the combiner may be used, for example, to adapt for drivers having different viewing positions such as, drivers of different heights or having different seating positions. In addition, the second mirror 52 may magnify the images and/or correct for distortions to image distortions caused by the windshield. The folding, tilting, magnifying, and correction functions may also be performed by a single mirror.

The combiner 54 or windshield 56 of a vehicle has a first reflective surface 58 and a second reflective surface 60 which may be parallel or have a wedge angle to the first reflective surface 58. Preferably the first reflective surface 58 is used to combine reflected views of the real images 38, 44 with the field of view to produce the virtual images 22, 24 overlying the field of view of the viewer 26.

A method for generating a plurality of virtual images 22, 24 with a multi-image head-up display device 20 is also provided. The method may include using a spatial light modulator 32 (SLM) having a first block 36 of modulating elements and a second block 42 of modulating elements, the method may comprise one or more of the steps of: providing a first projection surface 40 spaced apart from the spatial light modulator 32 by a first focal length 11; providing a second projection surface 46 spaced apart from the spatial light modulator 32 by a second focal length 12, illuminating the spatial light modulator 32 with a first light beam 34 by an illumination source 30. The method may proceed with the steps of: setting the first block 36 of modulating elements of the spatial light modulator 32 according to a first diffraction pattern to cause the first block 36 to function as a diffractive optical element (DOE); diffracting the first light beam 34 by the first block 36 of modulating elements of the spatial light modulator 32 to form a first real image 38 upon the first projection surface 40; setting the second block 42 of modulating elements of the spatial light modulator 32 according to a second diffraction pattern to cause the second block 42 to function as a diffractive optical element (DOE); and diffracting the first light beam 34 by the second block 42 of modulating elements of the spatial light modulator 32 to form a second real image 44 upon the second projection surface 46.

According to an aspect, the method may further include the step of: magnifying and directing the real images 38, 44 to the viewer 26 by a projection assembly 48 as the first virtual image 22 and as the second virtual image 24.

According to another aspect, the method may include the step of configuring a corresponding one of the blocks 36, 42 of modulating elements as a Fourier diffractive optical element (DOE) by generating at least one of the diffraction patterns using an iterative Fourier transform algorithm.

According to another aspect, the method may include the step of configuring a corresponding one of the blocks 36, 42 of modulating elements as a Fresnel diffractive optical element (DOE) by generating at least one of the diffraction patterns using an iterative Fresnel transform algorithm.

According to another aspect, the method may include the step of configuring a corresponding one of the blocks 36, 42 of modulating elements as a Fresnel diffractive optical element (DOE) by generating at least one of the diffraction patterns using an iterative Fourier transform algorithm; and adding to the at least one of the diffraction patterns, a phase function of a lens with a focal length equal to the length between the spatial light modulator 32 and a corresponding one of the projection surfaces 40, 46.

Obviously, many modifications and variations of the present invention are possible in light of the above teachings and may be practiced otherwise than as specifically described while within the scope of the appended claims.

1. A multi-image head-up display device for displaying a plurality of virtual images at different projection distances from a viewer, and comprising:
a picture generating unit (PGU) including an illumination source to illuminate a spatial light modulator (SLM) with a first light beam;
the spatial light modulator including a first block of modulating elements to diffract the first light beam according to a first diffraction pattern to form a first real image upon a first projection surface spaced apart from the spatial light modulator by a first focal length;
the spatial light modulator including a second block of modulating elements to diffract the first light beam according to a second diffraction pattern to form a second real image upon a second projection surface spaced apart from the spatial light modulator by a second focal length different from the first focal length.

2. The multi-image head-up display device as set forth in claim 1 wherein at least one of the first block of modulating elements or the second block of modulating elements is controllably variable to diffract the first light beam and to form a real image that is dynamically adjustable.

3. The multi-image head-up display device as set forth in claim 1 wherein both of the first block of modulating elements and the second block of modulating elements are controllably variable to diffract the first light beam and to form real images that are each independently dynamically adjustable.

4. The multi-image head-up display device as set forth in claim 1 wherein the illumination source includes a laser.

5. The multi-image head-up display device as set forth in claim 1 further including a projection assembly including a first mirror and a second mirror and a combiner; and
wherein the projection assembly magnifies and directs the real images to the viewer as the first virtual image having a first projection distance from the viewer and as the second virtual image having a second projection distance from the viewer different from the first projection distance.

6. The multi-image head-up display device as set forth in claim 5 wherein the first mirror reflects the real images from the projection surfaces to the second mirror, thereby providing a folded optical path within the projection assembly.

7. The multi-image head-up display device as set forth in claim 5 wherein the second mirror is tiltable for adjusting the location of the virtual images on the combiner.

8. The multi-image head-up display device as set forth in claim 5 further including a windshield of a vehicle including a first reflective surface functioning as the combiner to combine reflected views of the real images with the field of view to produce the virtual images overlying the field of view of the viewer.

9. The multi-image head-up display device as set forth in claim 1 wherein the spatial light modulator is a reflective Liquid Crystal on Silicon (LCoS) device that causes the first light beam to be diffracted as the first light beam is reflected by the modulating elements thereof.

10. The multi-image head-up display device as set forth in claim 1 wherein the spatial light modulator is a transmissive device that causes the first light beam to be diffracted as the first light beam is transmitted through the modulating elements thereof.

11. The multi-image head-up display device as set forth in claim 1 further including a first converging lens between the spatial light modulator the first projection surface.

12. The multi-image head-up display device as set forth in claim 1 further including a second converging lens between the spatial light modulator the second projection surface.

13. The multi-image head-up display device as set forth in claim 1 wherein light is projected directly between the spatial light modulator and at least one of the projection surfaces with no intermediate optical elements therebetween.

14. The multi-image head-up display device as set forth in claim 13 wherein at least one of the blocks of the spatial light modulator is configured according to a Fresnel pattern; and
wherein the at least one of the blocks of the spatial light modulator configured according to the Fresnel pattern projects one of the real images upon a corresponding one of the projection surfaces without a converging lens between the at least one of the blocks of the spatial light modulator configured according to the Fresnel pattern and the corresponding one of the projection surfaces.

15. A multi-image head-up display device for displaying a plurality of virtual images at different projection distances from a viewer, and comprising:
a picture generating unit (PGU) including an illumination source to illuminate a spatial light modulator (SLM) with a first light beam;
the spatial light modulator including a first block of modulating elements that are controllably variable to diffract the first light beam according to a first diffraction pattern to form a first real image upon a first projection surface spaced apart from the spatial light modulator by a first focal length;
the spatial light modulator including a second block of modulating elements that are controllably variable to diffract the first light beam according to a second diffraction pattern to form a second real image upon a second projection surface spaced apart from the spatial light modulator by a second focal length different from the first focal length; and
wherein the spatial light modulator is monolithic to include both of the first blocks of modulating elements together on one physical device.

16. A method for generating a plurality of virtual images with a multi-image head-up display device including a spatial light modulator (SLM) having a first block of modulating elements and a second block of modulating elements, the method comprising:
providing a first projection surface spaced apart from the spatial light modulator by a first focal length;
providing a second projection surface spaced apart from the spatial light modulator by a second focal length;
illuminating the spatial light modulator with a first light beam by an illumination source;
setting the first block of modulating elements of the spatial light modulator according to a first diffraction pattern to cause the first block to function as a diffractive optical element (DOE);
diffracting the first light beam by the first block of modulating elements of the spatial light modulator to form a first real image upon the first projection surface;
setting the second block of modulating elements of the spatial light modulator according to a second diffraction pattern to cause the second block to function as a diffractive optical element (DOE);
diffracting the first light beam by the second block of modulating elements of the spatial light modulator to form a second real image upon the second projection surface.

17. The method for generating a plurality of virtual images with a multi-image head-up display device as set forth in claim 16 further including the step of:
magnifying and directing the real images to the viewer by a projection assembly as the first virtual image and as the second virtual image.

18. The method for generating a plurality of virtual images with a multi-image head-up display device as set forth in claim 16 further including the step of:
configuring a corresponding one of the blocks of modulating elements as a Fourier diffractive optical element (DOE) by generating at least one of the diffraction patterns using an iterative Fourier transform algorithm.

19. The method for generating a plurality of virtual images with a multi-image head-up display device as set forth in claim 16 further including the step of:
configuring a corresponding one of the blocks of modulating elements as a Fresnel diffractive optical element (DOE) by generating at least one of the diffraction patterns using an iterative Fresnel transform algorithm.

20. The method for generating a plurality of virtual images with a multi-image head-up display device as set forth in claim 16 further including the step of:
configuring a corresponding one of the blocks of modulating elements as a Fresnel diffractive optical element (DOE) by:
generating at least one of the diffraction patterns using an iterative Fourier transform algorithm; and
adding to the at least one of the diffraction patterns, a phase function of a lens with a focal length equal to the length between the spatial light modulator and a corresponding one of the projection surfaces.
